(19) United States
(12) Patent Application Publication
(10) Pub. No.: US 2008/0195431 A1
(43) Pub. Date: Aug. 14, 2008

(54) SYSTEM AND METHOD FOR CORRELATING BUSINESS TRANSFORMATION METRICS WITH SUSTAINED BUSINESS PERFORMANCE

(75) Inventors: Naoki Abe, Rye, NY (US); Ramakalyani Tirumala Akkiraju, Yorktown Heights, NY (US); Stephen John Buckley, White Plains, NY (US); Markus Ettl, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/673,877

(22) Filed: Feb. 12, 2007

(51) Int. Cl. G06Q 10/00

(52) U.S. Cl. 705/7

(57) ABSTRACT

A system and method for correlating business metrics and business transformations includes correlating metrics between a first level and a second level within a business metric hierarchy, and correlating at least one business transform and at least one metric at the first of the plurality of levels.

### BACKGROUND OF THE INVENTION

1. Field of the Invention

The present invention generally relates to a system and method for correlating business transformation metrics with sustained business performance. In particular, the present invention provides a system and method for prioritizing business transformation initiatives.

2. Description of the Related Art

Today's companies are faced with new challenges, such as global competition, unprecedented advancements in technology, changing government regulations and global impact of local events. In this context, companies are forced to be flexible and adaptive even while keeping their expenditures in check. Given financial and resource constraints, managers are faced with critical decisions on where to invest resources to achieve maximum financial and operational impact. Defining appropriate metrics to measure a company's performance on an ongoing basis, tracking them over time and using historic information to identify key value drivers holds the key to identifying problem areas and thereby making informed business transformation investment decisions for maximizing financial impact.

Executives tend to focus their attention on underperforming financial metrics. Financial metrics are typically reported externally by a company and include, for example, revenue growth, return on investment capital, return on assets, and the like. In general, financial metrics provide an indication of a certain aspect of financial performance of a corresponding company. An executive at a company will typically monitor these financial metrics very closely to monitor the performance of the company.

When certain metrics are underperforming, an executive at a company may encourage certain business transformation initiatives. However, it is very difficult to determine how any given business transformation initiative will affect a financial metric. Typical business transformation initiatives focus on improving one or more operational processes. The direct impact of such improvements on the company's “bottom line” (as measured by the financial metrics such as revenue growth) may not be readily measurable. Therefore, it is desirable to prioritize business transformations in a manner which will reflect the affect that these business transformations have on those financial metrics that an executive wishes to see improved.

One conventional system provides a framework which integrates multiple perspectives to measure the effectiveness of an organization. These systems provide a strategic approach and performance management system that enables an organization to implement a vision and strategy. These conventional systems work from four perspectives: a financial perspective, a customer perspective, a business process perspective, and a learning and growth perspective. However, this conventional system framework does not specify the relationships among metrics, either within a perspective or across perspectives. Therefore, it is not possible to determine how any business transformation might affect these metrics.

Another conventional approach has relied upon industry efforts to define metrics for standard business processes which offer different perspectives. However, this approach does not provide any method for discovering the relationships among the metrics to identify areas for business transformation.

Yet another conventional system recognizes the need for considering leading indicators, such as innovation, along with lag indicators and shows the relationships between the lead and lag indicators. This system also helps identify cause-and-effect relationships through the use of strategy maps.

None of the conventional methods and systems uses a framework that combines metric management, portfolio management, and enterprise architecture to direct and prioritize business transformation investments to those activities that have the best impact on the (bottom-line) financial performance of an enterprise.

### SUMMARY OF THE INVENTION

In view of the foregoing and other exemplary problems, drawbacks, and disadvantages of the conventional methods and structures, an exemplary feature of the present invention is to provide a method and structure in which business metrics are correlated to business transformations.

In a first exemplary aspect of the present invention, a system for correlating business metrics and business transformations includes a metric correlator that correlates metrics between a first level and a second level within a business metric hierarchy, and a transformation correlator that correlates at least one business transform and at least one metric at a first of the plurality of levels.

In a second exemplary aspect of the present invention, a method of correlating business metrics and business transformations includes correlating metrics between a first level and a second level within a business metric hierarchy, and correlating at least one business transform and at least one metric at the first of the plurality of levels.

An exemplary embodiment of the present invention defines “On Demand” metrics that measure an enterprise's focus on concentrating on core competencies and assets that drive productivity, innovation and return; responsiveness in anticipating customer needs, business changes and unpredictable events; flexibility to adapt all business process capacity and cost structures in real time to respond to volatility and to reduce risk; or resilience to environmental changes and threats.

An exemplary embodiment of the present invention empirically evaluates the performance of a business through temporal models, qualitative analysis, or metric relationships to identify key performance drivers in (i.e. causal relationships between) operational metrics and on demand metrics in order to achieve a desired affect upon a business metric.

An exemplary embodiment of the present invention determines causal relationships between financial metrics, on demand metrics, and operational metrics and business transformations. In this manner, the effects of any particular business transformation upon these metrics may be accurately predicted and efforts may be focused upon those business transformations that provide a desired effect upon the metrics.

An exemplary embodiment of the present invention provides a method and system for assisting business managers in making intelligent business transformation investment decisions by correlating business transformation investments to sustained business performance.

An exemplary embodiment of the present invention uses predictive modeling techniques to correlate the financial metrics, the on demand metrics and the operational metrics to each other. In particular, the method determines which operational metrics play the most significant role in executive level “pain points” or those metrics that an executive might focus upon, such as, for example, financial metrics.

An output from an exemplary embodiment of the invention may be a list of operational metrics upon which company managers should focus their efforts upon. These metrics may then specifically be addressed using the business transformations that the invention identifies as having an affect upon.

An exemplary embodiment of the present invention continually and empirically evaluates business performance through temporal or qualitative analysis of the relationships between financial metrics, on demand metrics, and operational metrics. This embodiment may continually receive new data regarding financial metrics, business metrics, and operational metrics, from a business, empirically evaluate this data, and determine correlations between these metrics. For example, this embodiment may output a list of lower level metrics (such as, for example, operational metrics and/or on demand metrics) that drives upper level performance metrics (such as, for example, financial performance metrics) of the business.

An exemplary embodiment of the present invention uses portfolio optimization techniques to help decision makers identify and prioritize business transformations, and ensure that business transformation investment is allocated to operational focus areas that drive sustained financial performance. In this manner, the decision makers can focus upon those business transformations that improve selected metrics.

An exemplary embodiment of the present invention provides a user interface (e.g., a dashboard) that illustrates causal relationships between financial metrics, on demand metrics, operational metrics, and/or business transformations.

An exemplary embodiment of the present invention uses an empirical evaluation of business performance through temporal, empirical or qualitative analysis of metric relationships. This method and system calibrates metrics relationships either periodically or event-driven, and includes quantitative (e.g., temporal, empirical, etc.) or qualitative (e.g., directional, order of magnitude impact, etc.) relationships between metrics at different levels using analytical approaches.

An exemplary embodiment of the present invention identifies a company's problem areas, pain points and key value drivers and determines which of the company's metrics play the most significant role in driving on demand or financial performance. Based on company's pain points and correlation analysis, the embodiment identifies value drivers and operational metrics upon which the company should focus.

An exemplary embodiment of the present invention prioritizes business transformations. Once a company's pain points are identified and business value drivers established, the embodiment utilizes them in conjunction with metrics relationships to predict company performance. This helps determine the impact of transforming critical operational levers and allows managers to implement appropriate business transformations to resolve problem areas. Given a set of proposed business transformations, the embodiment employs a metrics analysis to identify causal relationships between metrics at different levels, such as operational metrics, on demand metrics, or financial metrics, and predict the top-level performance of the proposed. These techniques help allocate business transformation efforts to operational focus areas that drive sustained financial performance.

The combination of on demand metrics, value driver analysis, and the continual calibration of metrics relationships to prioritize business transformations by an exemplary embodiment of the present invention provides significant advantages.

One advantage of an exemplary embodiment of the present invention is that decision makers can, not only visualize and understand the on demand readiness of their company, but can also make intelligent decisions about which transformation projects to implement so as to achieve the highest impact on their company's financial performance.

The inventors have developed an approach to quantitatively assess a large set of performance metrics and identify those which are most relevant to a company's business. These metrics may include: established business metrics related to being on demand (i.e. focus, responsiveness, variability, resilience). An exemplary embodiment of the present invention uses a data mining technique that determines which operational metrics play the most significant role in executive level pain points. These operational metrics are the ones that require focused improvement.

An exemplary embodiment of the present invention links companies' value creation to overall financial performance in the marketplace.

An exemplary embodiment of the present invention uses data mining techniques to determine which operational metrics play the most significant role in the performance of business transformation initiatives.

While the above exemplary embodiments have described three layers of metrics, the present invention may operate with any number of layers of metrics. For example, an exemplary embodiment of the present invention may only have two layers of metrics, such as, financial metrics and operational metrics and still be capable of identifying correlations between these metrics and prioritizing business transformations to achieve a desired effect upon the metrics.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary business metric hierarchy 100;

FIG. 2 illustrates an exemplary scheme 200 of stylized “dashboards” in accordance with the present invention;

FIG. 3 is a block diagram 300 of a data structure in accordance with an exemplary embodiment of the present invention;

FIG. 4 is a flowchart 400 of an exemplary method in accordance with the present invention;

FIG. 5 illustrates another exemplary business metric hierarchy in accordance with the present invention;

FIG. 6 illustrates a typical hardware configuration 600 which may be used for implementing the inventive system and method; and

FIG. 7 illustrates signal-bearing media 700 and 702 each tangibly embodying a program of machine-readable instructions executable by a digital data processor to perform a method in accordance with the present invention;

FIG. 8 is a flowchart 800 of an exemplary method in accordance with the present invention; and

FIG. 9 illustrates an exemplary output 900 in accordance with the present invention.

### DETAILED DESCRIPTION OF EXEMPLARY EMBODIMENTS OF THE INVENTION

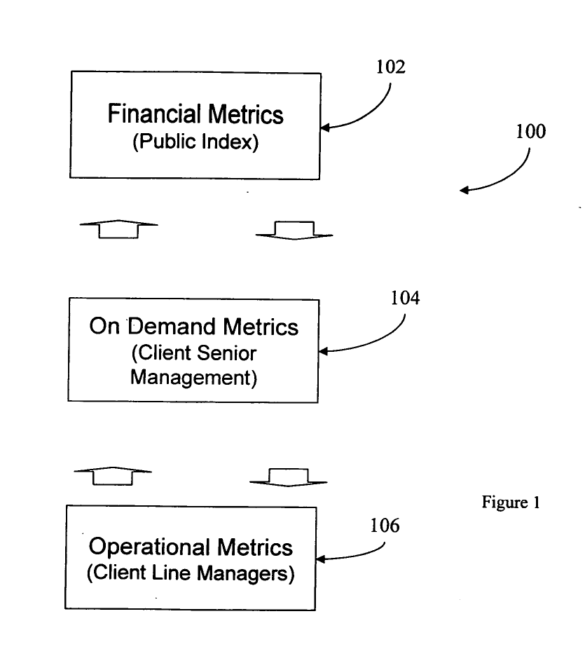

Referring now to the drawings, and more particularly to FIGS. 1-9, there are shown exemplary embodiments of the method and structures of the present invention.

FIG. 1 illustrates three exemplary levels of business metrics within a metric hierarchy 100 in accordance with an exemplary embodiment of the present invention. The three levels include financial metrics 102, on demand metrics 104, and operational metrics 106.

As explained above, financial metrics are typically reported externally by a company and include, for example, revenue growth, return on investment capital, return on assets, and the like. In general, financial metrics provide an indication of a certain aspect of financial performance of a corresponding company. An executive at a company will typically monitor these financial metrics very closely to monitor the performance of the company.

On demand metrics measure a) an enterprise's focus on concentrating on core competencies and assets that drive productivity, innovation and return; b) an enterprise's responsiveness in anticipating customer needs, business changes and unpredictable events; c) an enterprise's flexibility to adapt all business process capacity and cost structures in real time to respond to volatility and to reduce risk; and d) an enterprise's resilience to environmental changes and threats. On-demand metrics are intended to measure the enduring impact of business transformation activities. Business managers must determine whether a business is going to achieve on demand capabilities and must identify areas of greatest opportunity for business transformations to improve financial and on demand performance.

On demand metrics may be classified into categories, such as, for example, innovation, managing volatility, and anticipating and shaping demand. On demand metrics which are categorized as being related to innovation include, for example, research and development spending, research and development revenue, and the like and the compound annual growth rate pertaining to these metrics. On demand metrics which are categorized as being related to managing volatility include capital expenditures, capital revenue, compound annual growth rate, and the like and the compound annual growth rate pertaining to these metrics. On demand metrics which are categorized as being related to anticipating and shaping demand include inventory cost, inventory revenue, and the like and the compound annual growth rate pertaining to these metrics. In general, senior level managers of companies are interested in on demand metrics.

Operational metrics are measures of performance of an enterprise, based on the operational behavior of the enterprise over time. Operational metrics may be categorized and may include metrics such as inventory turns, inventory write offs, stockouts, supplier performance indexes, procurement cost, manufacturing cost, manufacturing lead times, warehousing costs, material handling costs, and the like. In general, line level managers of companies are interested in operational metrics.

An exemplary embodiment of the present invention determines causal relationships between financial metrics, on demand metrics, and operational metrics and business transformation initiatives. Business transformation initiatives are generally directed at a transformation of business processes and/or structures. For example, a procurement transformation initiative is aimed at improving operational metrics that are related to procurement. This embodiment is capable of predicting and analyzing the affect that such a procurement transformation initiative has upon operational metrics, on demand metrics, and financial metrics. The embodiment performs a causal relationship (also known as a “value driver”) analysis to determine these affects.

Another exemplary business transformation may involve changing from a geographically separate and independent customer relationship management system to an enterprise-wide customer relationship management system.

Yet another exemplary business transformation metric may involve outsourcing, where manufacturing of a product is moved from production by employees of the company to a system where production of products is handled by a supplier to the company. Such a transformation may require transferring capital and labor resources within the company and/or away from the company.

An exemplary embodiment of the present invention may predict the affects of multiple alternative business transformation initiatives upon business metrics and, in such a manner, may prioritize these initiatives to determine which has a desired result upon a selected metric.

For example, if an overall goal of a company is to improve revenue growth, then in a first pass of the inventive analysis the invention determines which on demand metrics drive revenue growth and which operational metrics drive those on demand metrics that drive revenue growth.

Then from a given portfolio of potential business transformations, the invention is able to prioritize those transformation initiatives that specifically address the operational metrics that are value drivers to revenue growth.

The causality that is identified by the present invention in the metric network helps identify the operational metrics that would have the best impact on the underperforming financial metrics while at the same time creating enduring business value. This capability enables executives to prioritize business transformation investments to those activities that have the best impact on the financial performance of the enterprise.

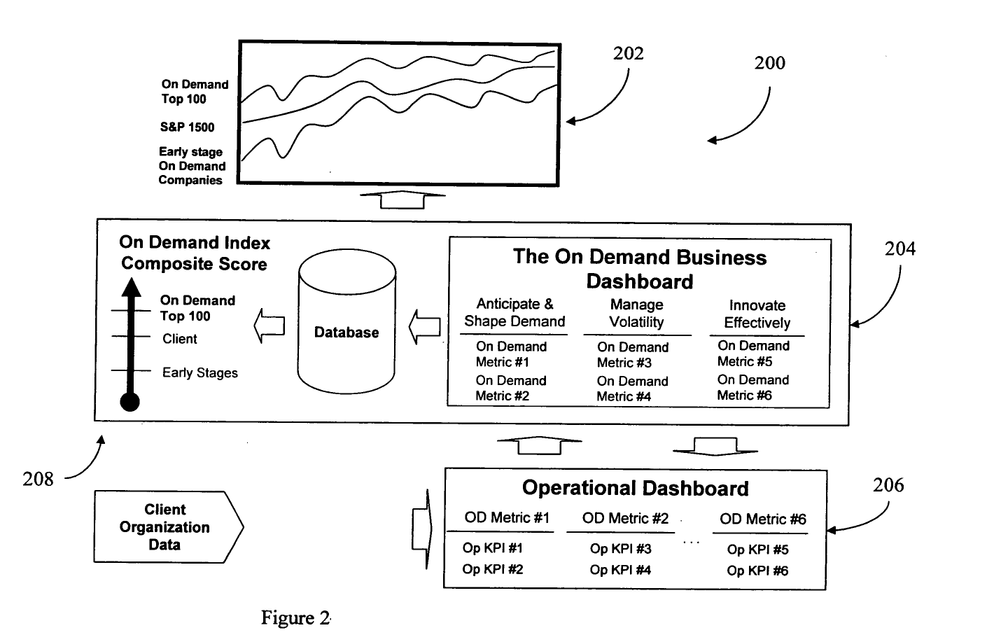

FIG. 2 illustrates an exemplary scheme 200 of stylized dashboards in accordance with an exemplary embodiment of the present invention. The figure illustrates an operational metrics dashboard 206, an on demand metrics dashboard 204, and a financial metrics dashboard 202. The operational metrics dashboard 206 may be accessed by, for example, line managers who focus upon specific areas within the corporation, such as, for example, customer relationship management, internal manufacturing operations, supplier management, and the like. These operational metrics are specific to the operations of the company and are typically directly controlled by line managers, such as, for example, the amount of stock out of specific products, the amount of inventory turns for a specific product or product line, order entry to delivery lead times, manufacturing costs, and the like. All of these metrics are displayed by the operational metrics dashboard 206 and may be categorized in certain ways, such as, for example, high level, supplier management, manufacturing, distribution categories and the like.

A similar dashboard 204 is provided for the on demand metrics. The on demand metrics in this figure are represented in three key areas: 1) innovation; 2) managing volatility; and 3) anticipating and shaping demand. The on demand metrics within these areas describe the characteristics of the company. These metrics are grouped within certain categories and displayed by the on demand business dashboard 204.

The scale 208 on the on demand metrics dashboard gives a decision maker an assessment of how a company compares to other companies, for example, in the same industry. The on demand metrics are translated into an index such as, for example, from zero to 100, and the top companies within this particularly industry segment perform in the top five percentile and the decision maker is able to view how their company ranks on that scale.

The financial metrics dash board 202 level illustrates financial performance metrics for a company. For example, the dash board 202 of FIG. 2 illustrates the financial performance of a company with respect to the Standard and Poors® rating system.

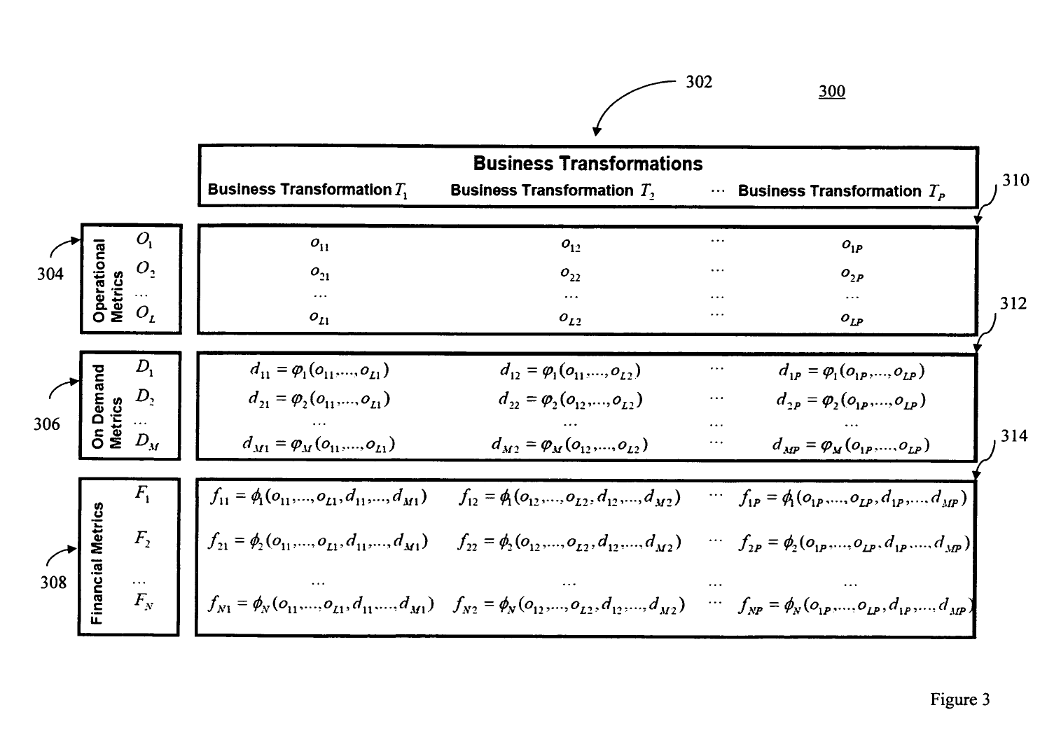

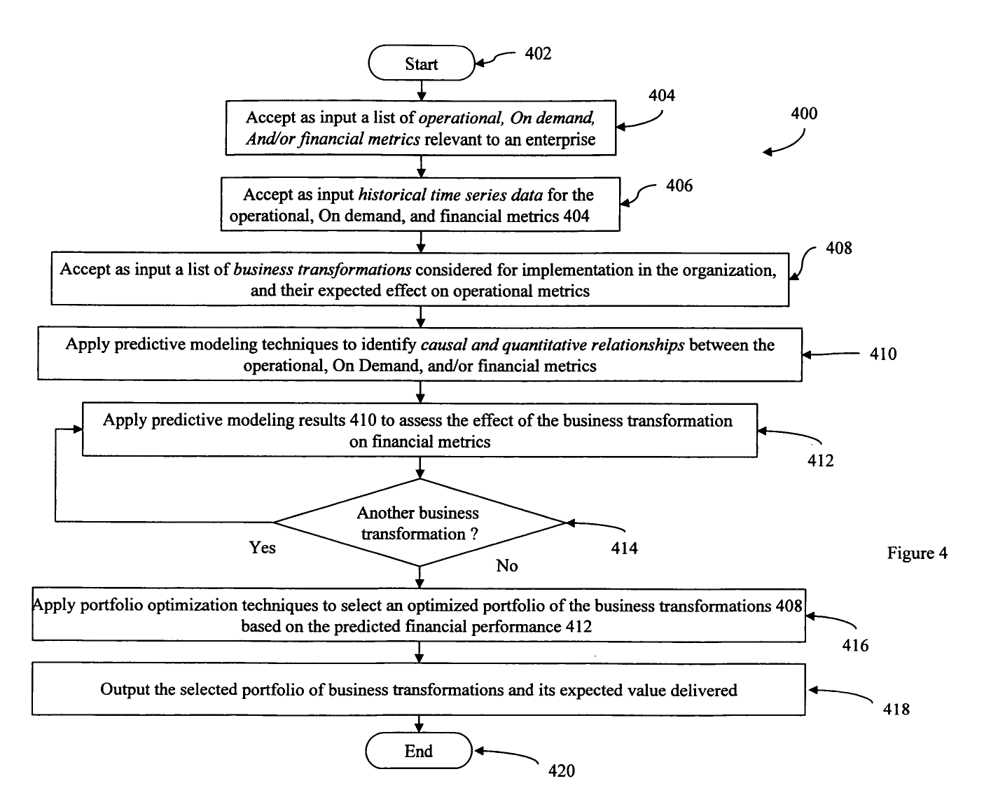

FIG. 3 is a block diagram that illustrates the data structures of an exemplary embodiment of the invention that may be utilized by the method of the flowchart of FIG. 4.

Assume that an organization has identified a set of L operational metrics 304, labeled Oₗ for l=1,2, . . . , L, a set of M on demand metrics 306, labeled Dₘ for m=1,2, . . . , M, and a set of N financial metrics 308, labeled Fₙ n=1,2, . . . , N. Suppose that business transformation experts develop a set of P tentative business transformations 302 for the organization, denoted by Tₚ for p=1,2, . . . , P. Each business transformation project targets specific business processes within the organization, and aims to directly improve one or more operational metrics 304.

Subsequently, the business transformation experts establish performance targets 310, labeled oₗₚ for every business transformation project p and every operational metric Oₗ that is targeted by business transformation project p. The performance targets oₗₚ can be provided in the form of an absolute value (e.g., decrease inventory carrying costs of the organization from $5M to $4M), or in the form of a relative improvement (e.g., reduce inventory carrying costs by 20 percent). Each business transformation project p may influence only a subset of the operational metrics 304.

FIG. 4 illustrates a flowchart of one exemplary method in accordance with the present invention. The flowchart 400 starts at step 402 and continues to step 404. In step 404, the exemplary embodiment accepts as input a list of operational metrics 304, a list of On Demand metrics 306, and/or a list of financial metrics 308. The method continues to step 406 where the exemplary embodiment accepts as input historical data (i.e., time series data) for the operational metrics 306, labeled Oₗ, the on demand metrics 306, labeled Dₘ, and/or the financial metrics 308, labeled Fₙ. In step 408 the exemplary embodiment accepts as input a list of business transformations 302 considered for implementation in an organization, and their expected effect on operational metrics 310.

The flowchart continues to step 410 where the exemplary embodiment may apply predictive modeling techniques, such as, for example, linear regression or transform regression, to the historical data in order to develop functional relationships φₘ(o₁ₚ, . . . , o_{Lp}) that predict the performance value dₘₚ of the on demand metrics when given the performance targets o₁ₚ, . . . , o_{Lp} of the operational metrics that were established for transformation project p. Using the functional relationships φₘ, an exemplary embodiment of the invention may evaluate the performance values dₘₚ for every on demand metric Dₘ and every transformation project p. As a result of this step it is possible to quantitatively predict how one or more of the on demand metrics Dₘ will change if transformation project p were executed. In step 410, the exemplary embodiment may further apply predictive modeling techniques, such as linear regression or transform regression, to the historical data in order to develop functional relationships φₙ(o₁ₚ, . . . , o_{Lp}, d₁ₚ, . . . , d_{Mp}), that predict the performance value fₙₚ of financial metric Fₙ when given the performance goals oₗₚ of the operational metrics Oₗ that were established for transformation project p and the performance values dₘₚ of the on demand metrics Dₘ that were established for transformation project p.

Using the functional relationships φₙ established in step 410, the exemplary embodiment iterates between step 412 and step 414 to evaluate performance values fₙₚ for every financial metric Fₙ and every transformation project p to quantitatively predict how one or more of the financial metrics Fₙ will change if transformation project p were executed. Because the combination of several business transformations may result in less than the sum of the individual expected transformation targets, the exemplary embodiment may apply multivariate data analyses such as factor design, cluster analysis, or transform regression to accurately model interactions between business transformation projects and financial metrics.

The flowchart continues to step 416 where the exemplary embodiment applies portfolio optimization techniques to select an optimized portfolio of business transformations based on the predicted financial performance of the business transformations established in steps 412 to 414. For example, L. K. Nozick, M. A. Turnquist, and N. Xu. Managing Portfolios under Uncertainty. Annals of Operations Research, 132, 243-256 (2004), discloses a system and method which may be used to optimize the portfolio. The selected subset of business transformations may maximize a utility function that measures the return on investment subject to a number of physical or business constraints, including budget limitations, resource constraints, project dependencies, and business rules, etc. to help decision makers to collectively manage portfolio investment selections and maximize the value delivered by the project portfolio. In the present framework, the value delivered may be measured by an arbitrary utility function Z, for example, a linear combination of financial metrics

$$Z = {\sum }_{n} {w}_{n} {F}_{n}$$

with appropriately chosen weights wₙ that represent the relative importance of financial metric Fₙ.

In step 418, the exemplary embodiment outputs the selected portfolio of business transformations and the utility function pertaining to the selected portfolio, and continues to step 420 where the method ends.

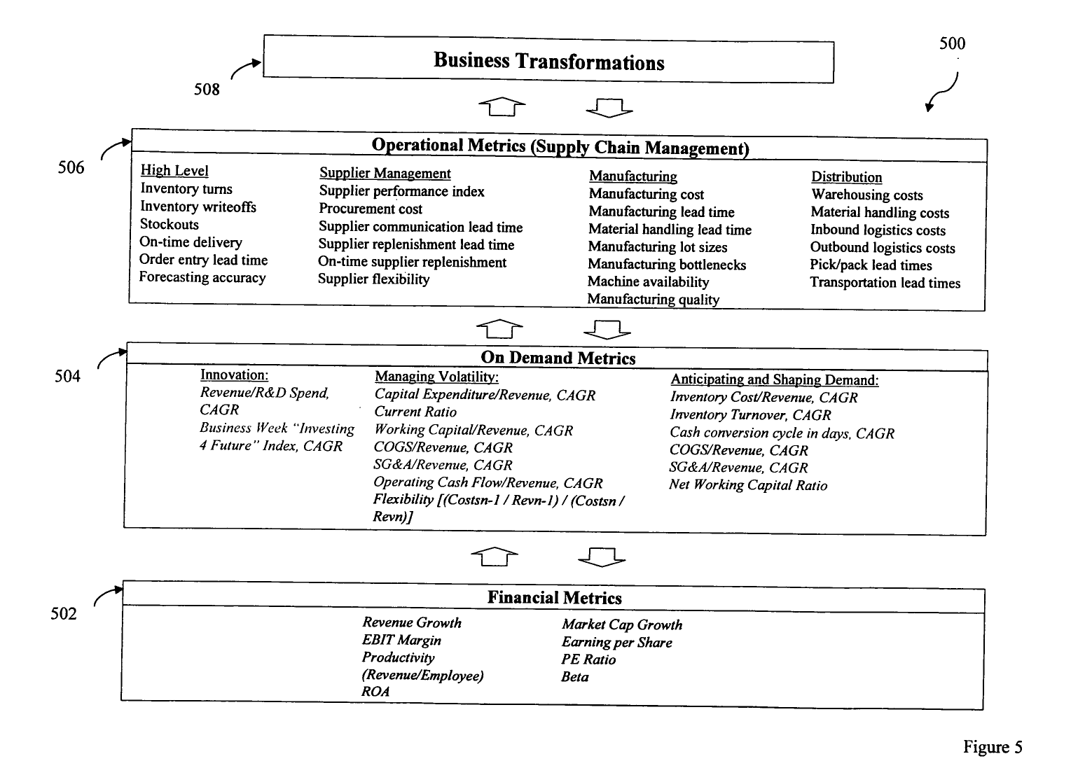

A first phase of an exemplary embodiment of the present invention determines correlations between metrics of different levels as applied to a business metrics hierarchy 500 of FIG. 5. The correlations are determined as described above with reference to step 410 of the flowchart of FIG. 4. For the following example, correlations between on demand metrics 504 and financial performance metrics 502 will be analyzed to determine correlations between these metrics.

The financial performance metrics 502 may include revenue growth, earnings before interest and tax (EBIT), productivity (revenue/employee), return on assets (ROA), market capital growth, earnings per share (EPS), price/earnings (P/E) ratio, and/or beta.

The on demand metrics 504 may include metrics relevant to: 1) Innovation: Revenue/R&D Spend (absolute and compound annual growth rate, or CAGR), Business Week “Investing 4 Future” Index (absolute and CAGR); 2) Managing Volatility: Capital Expenditure/Revenue (absolute and CAGR), Current Ratio, Working Capital/Revenue (absolute and CAGR), COGS/Revenue (absolute and CAGR), SG&A/Revenue (absolute and CAGR), Operating Cash Flow/Revenue (absolute and CAGR), Flexibility [(Costs(n−1)/Rev(n−1)/(Costs(n)/Rev(n))]; and/or 3) Anticipating and Shaping Demand: Inventory Cost/Revenue (absolute and CAGR), Inventory Turnover (absolute and CAGR), Cash conversion cycle in days (absolute and CAGR), SG&A/Revenue (absolute and CAGR), Net Working Capital Ratio, Demand Management Index.

For the above on demand metrics “flexibility” is intended to quantify an enterprise's ability to expand margins as revenues rise and maintain margins as revenues fall and a “Demand Management Index” is a combination of other indices in the index group for “Anticipating and Shaping Demand”.

All or some of the above metrics may be input into an exemplary embodiment of the present invention. Preferably, this data is normalized. For example, the data in each the values in each column of data is normalized by subtracting a sample mean and dividing it by a standard deviation, within each industry group.

Additionally, preferably, outliers are filtered out. For example, the normalized values in each column that are a standard deviation or more away from a mean are discarded and treated as “missing values”

Given the input data including realized values of metrics, an exemplary embodiment of the present invention quantifies the correlations that may exist between the operational metrics 506 and on-demand metrics 504 and the financial metrics 502, by performing either predictive modeling or correlation analysis, or a combination of both.

Predictive modeling refers to the statistical modeling of each of the financial metrics 502, in terms of a regression function of the operational and on-demand metrics.

The statistical modeling may be performed, for example, by conducting linear regression of each of the financial metrics 502 in terms of the operational metrics 506 and the on-demand metrics 504. Linear regression can be realized by a standard procedure.

Since linear regression is not able to satisfactorily capture non-linear relationships that may exist between the metrics, a more sophisticated method of regression may be used in place of the standard linear regression. For example, an advanced regression method known as Transform Regression may be used in place of standard linear regression for possible accuracy enhancement.

Transform regression is an advanced regression method which goes beyond traditional regression methods such as stepwise linear regression, and is inspired by a gradient boosting method. (See, for example, E. Pednault, Transform Regression and the Kolmogorov Superposition Theorem, in Proceedings of the Sixth SIAM International Conference on Data Mining, 2006, Bethesda, Md.) The merits of the transform regression method is advantageous because it applies non-linear transformation to the explanatory variables in its modeling process and thus handles non-linear dependence and interactions among variables, and it enjoys superior predictive accuracy, as compared to other existing tools and methods in the market.

Transform Regression is loosely motivated by the Kolmogorov Superposition Theorem, and applies it in the context of “gradient boosting”. The Kolmogorov Superposition Theorem states that every continuous function can be expressed as the sum of a relatively small number of functions, which are each a linear combination of “transforms” of the input variables. Gradient boosting is a new technique, which was obtained by generalizing the renowned AdaBoost procedure for classification. The intuitive idea of gradient boosting is that at each stage, an estimator is used to approximate the input function, and in subsequent stages the residuals from the previous stage are approximated using the same estimator, so as to minimize the estimation error with respect to the residuals. The process is then continued until near convergence. The final output model is the weighted additive model including all the models obtained in the respective stages. Transform Regression performs gradient boosting, using in each stage a linear function of non-linear transforms, thus resulting in a final model in the form of the Superposition Theorem.

The actual implementation of a Transform Regression method departs in a number of ways from the theory outlined above. First, the non-linear transform is obtained using a particular regression method called Linear Regression Tree (LRT) method. Specifically, each method is obtained as a linear regression tree on the raw variable in question. In addition, instead of allowing an arbitrary function of these transformed variables in each stage, it is restricted to be the simple sum of all the transforms, except that these transforms are allowed to depend on the outputs of all models from the preceding stages, realizing the desired richness in expressive power of the resulting model class. In particular, this is realized by obtaining the transform of each variable as a linear regression tree, allowing as input variables the variable in question as well as the outputs of all previous models.

Using an output model obtained by applying Transform Regression, one can obtain the so-called “feature importance information.” This feature importance information may be obtained by performing “variable perturbation” for each variable, using the output model. Thus, the feature importance score reflects how much change in the target variable is expected by a random perturbation in the explanatory variable in question.

The feature importance values thus obtained may be output as the results of step 410 of the flow chart in FIG. 4, and can be used as input to the subsequent steps.

The use of predictive modeling, as described above, is one exemplary embodiment of the present invention. This approach is not free of disadvantages. To the extent that the model captures the non-linear effect of each explanatory variable, the feature importance also reflects such effects. However, the importance measure of a given feature is fundamentally dependent on the particular model output by the method, and hence is not free of some fundamental shortcomings common in any regression method. For example, if two explanatory variables are highly correlated with one another, it is very likely that the regression model will include one but not the other, at least with a significant coefficient. In such a case, one of the variables will receive a high feature importance, whereas the other will be assigned a negligible feature importance. In order to address this shortcoming of predictive modeling, it is also possible to have unsupervised correlation analysis for step 404 of the flowchart of FIG. 4.

Unsupervised correlation analysis differs from statistical regression modeling in that no particular target variable to be predicted is specified a priori. More precisely, statistical regression modeling constructs a statistical model that predicts the value of the specified target variable, as a function of the specified explanatory variables. In unsupervised correlation analysis, no particular variable is specified as a target variable. Rather, the goal is to quantify the structure and degree of correlation that exists among all the variables, given a data set that consists of multiple records each of which contains a vector of realized values of the variables. The output of such an unsupervised correlation analysis, which includes the correlation information between the on-demand metrics and the financial metrics, can then be used in the subsequent steps.

A popular framework for what is called “unsupervised correlation analysis” is that of Bayesian Networks, also known as the graphical models. (See, for example, Heckerman, David, “A Tutorial on Learning with Bayesian Networks”, in “Learning in Graphical Models, Jordan, M., editor, MIT Press, Cambridge, Mass., 1999.) A Bayesian network is a directed acyclic graph of nodes representing variables and arcs representing probabilistic dependency relations among the variables. However, this approach of using Bayesian Network estimation for the purpose of correlation analysis suffers from the shortcoming that intensive computation is required for the estimation of Bayesian Networks. This is in part due to the fact that a search for a near optimal network structure within given data tends to require an amount of computation which is exponential or more than exponential in the number of variables in question, and this is often prohibitive in practical applications. For this reason, using an estimation procedure for the entire, unrestricted class of Bayesian networks for the purpose of causal modeling and outlier detection based upon data analysis performed on a large scale data set is not practical, and it is necessary that some restriction be placed on the class of networks to consider in the modeling process.

An example of restricted subclass of Bayesian Networks, for which an efficient estimation procedure is known to exist, is the class of Chow-Liu trees, also known as the dendroids, or dependency trees. (see, for example, Chow, C., and Liu, C. 1968, “Approximating discrete probability distributions with dependence trees”, IEEE Transactions on Information Theory, 14(11):462-467.) The dependency tree estimation method can be based on the classic maximum likelihood estimation method for dependency trees, or a related estimation algorithm based on the related criterion of the Minimum Description Length Principle.

The dendroid, or dependency tree, is a certain restricted class of probability models for a joint distribution over a number of variables, x₁, . . . xₙ, and takes the following form:

P(x₁, . . . xₙ)=P(x₁)π_{(xi,xj)εG}P(xᵢ|xⱼ) (1)

where G is a graph, which happens to be a tree. x₁ here is called the root of the tree. A dependency forest is simply a finite set of dependency trees, each defined on a disjoint subset of the variables.

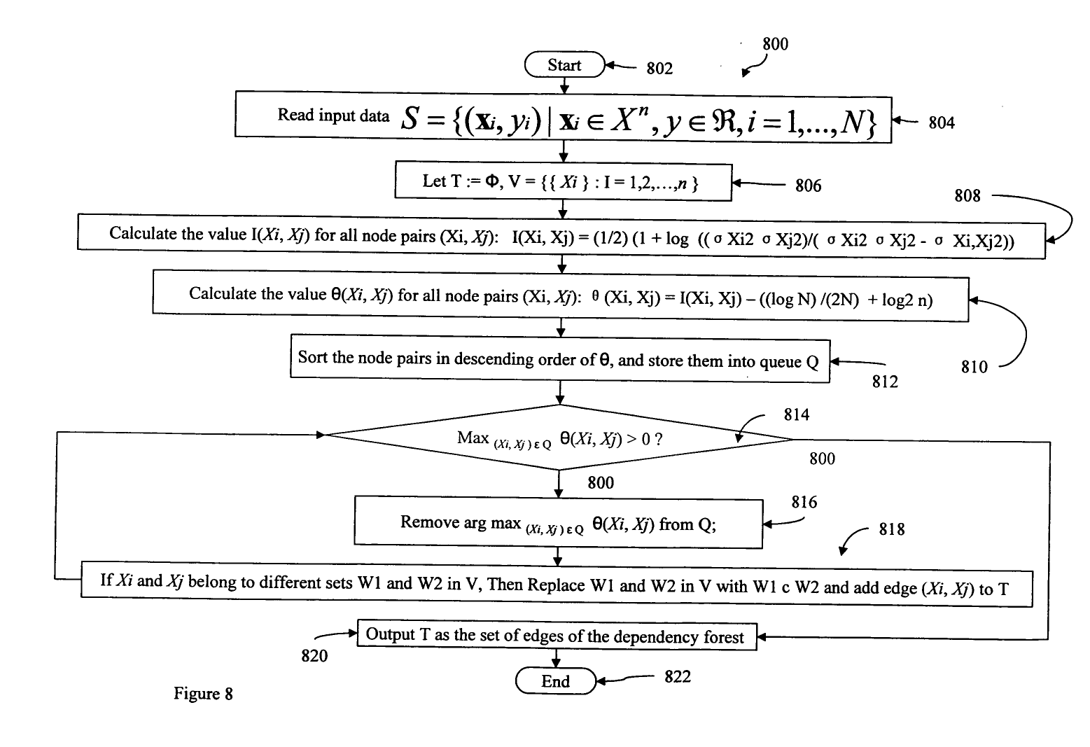

FIG. 8 provides a flowchart 800 of an exemplary method which is finds an optimal dependency forest with respect to the Minimum Description Length principle. For ease of description, the method is exhibited for the case of discrete variables, N denotes the size of the training sample, and n denotes the number of variables. Also, I(Xᵢ, Xⱼ) denotes the empirical mutual information between the two continuous variables observed in the data, assuming that they are both Gaussian variables, i.e.:

I(Xᵢ, Xⱼ)=(½) (1+log ((σ_{Xi}²σ_{Xj}²)/(σ_{Xi}²σ_{Xj}²−σ_{Xi,Xj}²)) (2)

Upon receiving the input data S in step 804, the following assignment is performed, in step 806.

Let T:=Φ, V={{Xᵢ}: I=1,2, . . . , n}; (3)

The method then calculates the value θ(Xᵢ, Xⱼ) for all node pairs (Xᵢ, Xⱼ), in steps 808 and 810.

θ(Xᵢ, Xⱼ)=I(Xᵢ, Xⱼ)−((log N)/(2N)+log₂ n) (4)

The method then sorts the node pairs in descending order of 0, and store them into queue Q in step 812. Next, in step 814, it checks to see if the following condition holds

(max_{(Xi, Xj)εQ}θ(Xᵢ, Xⱼ)>0)

The method also repeats the following block of statements, in steps 816 and 818;

Remove arg max_{(Xi, Xj)εQ}θ(Xᵢ, Xⱼ) from Q;

If Xᵢ, and Xⱼ belong to different sets W₁ and W₂ in V

Then Replace W₁ and W₂ in V with W₁ U W₂ and add edge (Xᵢ, Xⱼ) to T; and

Finally, if and when the method determines that the condition (max_{(Xi, Xj)εQ}θ(Xᵢ, Xⱼ)>0) of step 814 no longer holds, the method proceeds to step 820 and outputs T as the set of edges of the desired dependency forest.

An exemplary embodiment of the present invention applies the above “dependency forest” estimation method to the input data as part of step 410 of the flowchart of FIG. 4. The output of this estimation can be used in at least two ways. One way is to use the output dependency trees and the correlation coefficients that are associated with each of the dependencies identified by the method as the measures of correlation between the metrics to be used in the subsequent phases. Another way is to perform both statistical regression modeling and unsupervised correlation analysis, and then combine the feature importance information output by the former with the correlation coefficients output by the latter. For example, for any given pair of metrics, X and Y, it is possible to associate the maximum of the feature importance of X in predictive modeling of Y, and the correlation coefficient for X, Y, either directly included in the output dependency trees or computed as a function of the correlation coefficient between X and Z and Z and Y for some other intermediate feature Z. This way, the variables that have high feature importance, but do not appear so in the statistical modeling due to some other predictive feature that is correlated with it, can be discovered to have high feature importance.

Another exemplary embodiment of the invention applies, in step 410 of the flowchart of FIG. 4, the above “dependency forest” method to the transformed features used in an intermediate stage of the Transform Regression method, rather than the raw variables. This can be done by extracting the correlation table information from the output model of Transform Regression, which is computed with respect to the transformed variables. In particular, they are the outputs of the first stage in the theory described in the section on Transform Regression, that is, each variable Xᵢ is transformed to h(Xᵢ) where h is the output variable of the univariate LRT, using only Xᵢ as splitting variables (in the tree) as well as the model variable in the leaf models. That is, h(Xᵢ) is a univariate piecewise linear regression model of the target variable, in terms of Xᵢ.

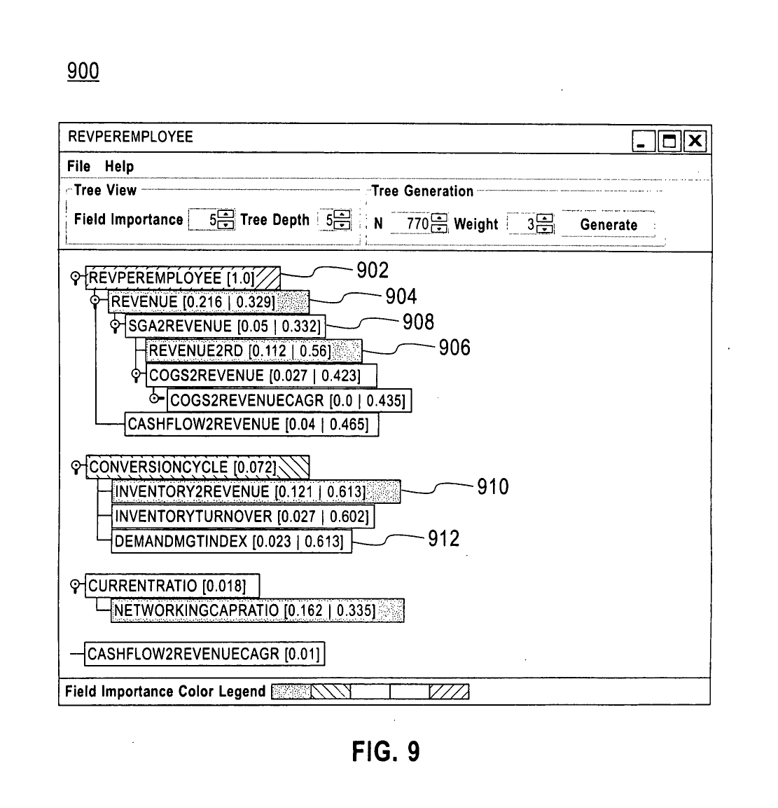

FIG. 9 shows an example tree output 900 of applying the above Dependency Forest method to an output model of transform regression, in particular, for the modeling of “Revenue per Employee” 902 as a target variable. Each of the nodes in the tree 900 has one or two numbers associated with each node. These numbers indicate the feature importance with respect to the prediction of the target variable assigned by the transform regression method, as well as, the correlation coefficient that is determined by the dependency method that are described above. In particular, the first number indicates the feature importance assigned to it by the transform regression and the right number indicates the correlation coefficient between the specific feature and that features immediate parent. For example, the “REVENUE2RD” feature 906 has a transform regression assigned importance of 0.112 and a correlation between feature 906 and its immediate parent (“SGA2REVENUE” 908) of 0.56. When a node lacks an immediate parent node, of course, the node does not include a correlation coefficient number for a parent node.

The output tree 900 clearly illustrates that the “INVENTORY2REVENUE” 910 feature has a high transform regression assigned number of 0.121 and a high correlation coefficient with its parent of 0.613. This indicates that the “INVENTORY2REVENUE” 910 feature is a “key driver” for the target financial metric of “REVPEREMPLOYEE” 902. Similarly, the output tree 900 also clearly illustrates that the “DEMANDMGTINDEX” 912 feature is not a “key driver” because, although its correlation coefficient with its parent is the same as the “INVENTORY2REVENUE” 910 feature, the number assigned by the transform regression is a relatively low 0.023. This example illustrates a potential use of the dependency forests, as an additional source of information to the feature importance information output by regression modeling.

In an exemplary embodiment of the present invention (not shown), the output may indicate the relative importance of the features using colors. For example, the colors cyan, green, and yellow may be used to highlight the features having the highest importance scores, in decreasing order and indicate the target variable in another color, such as, for example, red. In this manner, the relative importance may be quickly understood by a user observing the output.

While the above description has been in terms of the particular analysis methods and tools, it is understood by those of ordinary skill in the art that a similar analysis may be performed with other tools and still practice the invention.

For example, the transform regression procedure can be simulated approximately as follows. The feature transformation aspect, which is the most relevant to the subsequent correlation analysis using the dependency trees tool, however, can be approximated using more standard tools. For example, a similar effect can be obtained by constructing univariate GAMs models, or Generalized Additive Models, (See, for example, Hastie, T. J. and Tibshirani, R. J., Generalized Additive Models, New York, Chapman and Hall, 1990.) for each numeric input feature xᵢ, and univariate CART regression tree models for each categorical input feature xᵢ. (See, for example, Breiman, L., J. H. Friedman, R. A. Olshen, C. J. Stone, Classification and Regression Trees, Chapman and Hall, 1984.)

“Dependency Forest” is only one of many potential methods that may be used to analyze the correlation structure among the variables. One possibility would be to use other methods for “structure learning” of graphical models, or Bayesian networks. Another possibility is to use some other method of visualizing the information present in a correlation matrix for the explanatory variables, such as Multi-dimensional scaling.

Based upon the above described method both the feature importance information output by Transform Regression and the dependency trees output by the Dependency Trees tool may be visually presented.

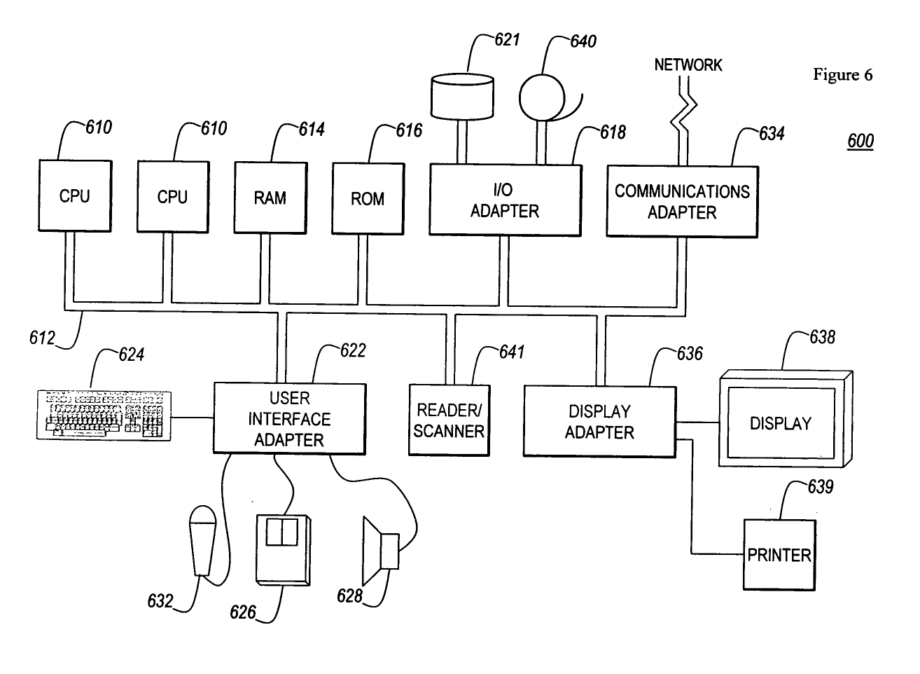

Referring now to FIG. 6, system 600 illustrates a typical hardware configuration which may be used for implementing the inventive system and method for buying and selling merchandise. The configuration has preferably at least one processor or central processing unit (CPU) 610. The CPUs 602 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, and Intranet, a personal area network (PAN), etc., and a display adapter 636 for connecting the bus 612 to a display device 638 and/or printer 639. Further, an automated reader/scanner 641 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 610 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 610 and hardware above, to perform the method of the invention.

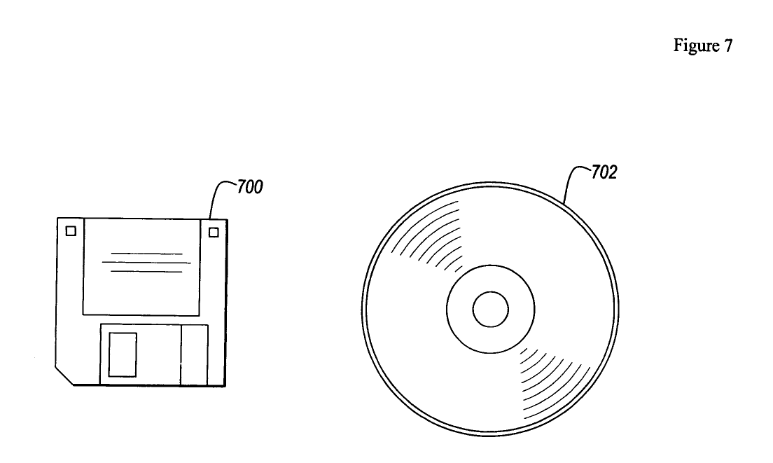

This signal-bearing media may include, for example, a RAM contained within the CPU 610, as represented by the fast-access storage for example. Alternatively, the instructions may be contained in another signal-bearing media, such as a magnetic data storage diskette 700 or CD-ROM 702, (FIG. 7), directly or indirectly accessible by the CPU 610.

Whether contained in the computer server/CPU 610, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. A system for a correlating business metric and a business transformation comprising:
a metric correlator that correlates metrics between a first level and a second level within a business metric hierarchy; and
a transformation correlator that correlates at least one business transform and at least one metric at a first of said plurality of levels.

2. The system of claim 1, wherein said transformation correlator correlates a plurality of business transforms to at least one metric at said first level.

3. The system of claim 2, further comprising a transformation selector that selects one of said plurality of business transforms based upon said correlations between said plurality of business transforms and said at least one metric at said first level and between said at least one metric at said first level and a metric at a second level of said plurality of levels.

4. The system of claim 3, wherein said transformation selector selects said business transform based upon a predicted effect upon said metric at said second level.

5. The system of claim 1, wherein plurality of levels comprises a financial metric level, an on-demand metric level, and an operational metric level.

6. The system of claim 5, wherein said financial metric level comprises business metrics regarding one of revenue growth, return on investment, return on assets, and return on capital.

7. The system of claim 5, wherein said on demand metric level comprises business metrics regarding one of:
a) a focus on concentrating on core competencies and assets that drive productivity, innovation, and return;
b) responsiveness in anticipating customer needs, business changes, and unpredictable events;
c) variability to adapt capacity and cost structures to respond to volatility and to reduce risk; and
d) resilience to environmental changes and threats.

8. The system of claim 5, wherein said operational metric level comprises business metrics regarding one of information technology metrics and performance metrics.

9. The system of claim 1, wherein said metric correlator correlates metrics between said plurality of levels using a predictive modeling technique.

10. The system of claim 1, wherein said metric correlator correlates said metrics periodically.

11. The system of claim 1, wherein said metric correlator correlates said metrics using one of a data mining technique, a value modeling tool, a visualization technique, and a statistical technique.

12. A method of a correlating business metric and a business transformation, comprising:
correlating metrics between a first level and a second level within a business metric hierarchy; and
correlating at least one business transform and at least one metric at the first of said plurality of levels.

13. The method of claim 12, wherein said correlating at least one business transform and at least one metric at the first of said plurality of levels comprises correlating a plurality of business transforms to at least one metric at said first level.

14. The method of claim 12, further comprising selecting one of a plurality of business transforms based upon said correlations.

15. The method of claim 14, wherein said selecting comprises selecting said business transform based upon a predicted effect upon said metric at said second level.

16. The method of claim 12, wherein said correlating metrics comprises correlating metrics using a predictive modeling technique.

17. The method of claim 12, wherein said correlating metrics comprises correlating metrics using one of a data mining technique, a value modeling tool, a visualization technique, and a statistical technique.

18. The method of claim 12, wherein said business metric hierarchy comprises a financial metric level, an on-demand metric level, and an operational metric level.

19. A program embodied in a computer readable medium executable by a digital processing system for correlating business metrics and business transformations, said program comprising instructions for executing the method of claim 12.

20. A system for correlating a business metric and a business transformation, comprising:
means for correlating metrics between a first level and a second level within a business metric hierarchy; and
means for correlating at least one business transform and at least one metric at the first of said plurality of levels.
